(19) United States
(12) Patent Application Publication
(10) Pub. No.: US 2011/0199615 A1
(43) Pub. Date: Aug. 18, 2011

(54) OPTICAL COHERENCE TOMOGRAPHIC IMAGING APPARATUS

(75) Inventor: Mitsuro Sugita, Tokyo (JP)

(73) Assignee: CANON KABUSHIKI KAISHA, Tokyo (JP)

(21) Appl. No.: 12/678,414

(22) PCT Filed: Dec. 25, 2009
(86) PCT No.: PCT/JP2009/071895

§ 371 Date: Mar. 16, 2010

(30) Foreign Application Priority Data
Dec. 26, 2008 (JP) 2008-334530

(51) Int. Cl. G01J 3/45

(52) U.S. Cl. 356/456

(57) ABSTRACT

An optical coherence tomographic imaging apparatus for splitting light emitted from a light source into reference light and signal light and creating an optical coherence tomographic image and tomographic spectral information in a predetermined spectral analyzing portion in the optical coherence tomographic image based on optical interference signal information of the reference light and the signal light which are incident on an inspection target and reflected on respective layers, the optical coherence tomographic imaging apparatus including a spectral information processing unit for performing a spectral information calculation using an optical interference signal of a deeper region and creating the tomographic spectral information of the spectral analyzing portion. With this arrangement, spectral information corresponding to the optical coherence tomographic image can be output with high wavelength accuracy.

### TECHNICAL FIELD

The present invention relates to an optical coherence tomographic imaging apparatus applied to a disease diagnosis apparatus and the like using, for example, a fundus/retinal image, and more particularly to an optical coherence tomographic imaging apparatus for creating tomographic spectral information together with an optical coherence tomographic image by optical interference signal information.

### BACKGROUND ART

Recently, an optical coherence tomographic imaging apparatus making use of a technique of a low-coherence interferometer or a white light interferometer has come into practical use. The device, which is often called OCT (Optical Coherence Tomography) device, is used particularly in an ophthalmologic field to obtain a fundus tomographic image. Further, the device also tries to perform a tomographic observation of a skin and tomographic imaging of digestive and circulatory organ walls by being arranged as an endoscope and a catheter in addition to the ophthalmology.

In the OCT device, low coherence properties are required for a light source. A low coherence light source has a wide spectrum as compared with a laser light source and the like having high coherence. A resolution of the OCT device is discussed as resolutions in two directions, that is, as a resolution in a tomographic direction (longitudinal direction) and a resolution in a lateral direction vertical to a tomography, wherein the resolution in the tomographic direction is determined by a spectrum width of a light source, and a wider spectrum width improves the resolution in the tomographic direction. That is, when a light source having a wide spectrum width is used, a narrow range can be drawn better in a longitudinal direction.

The longitudinal resolution Rz is inversely proportional to a wavelength width (spectrum width) of a light source or strictly to a wavelength width Δλ detected through a system after it is incident from the light source and is proportional to a square of a center wavelength and is shown by

Rz=kz×(λ²/Δλ). expression 1)

Here, kz is a constant of about 0.4.

A wavelength width Δλ in an actual OCT device is typically about 20 nm to 200 nm, and wavelength widths of 50 nm to 100 nm are commercially used among them. They have a considerably wide band in consideration that a typical wavelength width of a laser used for a scanning laser microscope and a scanning laser ophthalmoscope (SLO) is 5 nm or less.

Accordingly, in the OCT device for obtaining information by radiating the broadband light to a patient under examination, it is expected that spectral characteristics of the patient under examination, i. e., a spectral reflectance, a spectral absorption coefficient, a spectral dependence of dispersion, and the like can be measured at the same time.

To satisfy the expectation, a research of a so-called spectrum OCT is executed, a method using the Short Time Fourier transformation (STFT) shown in, for example, Non-Patent Document 1 is experimentally proven, and an arrangement disclosed in Patent Document 1 is proposed using this type of the technique. A typical mode using the conventional method will be described below with reference to FIGS. 15 to 20.

In FIG. 15, light emitted from a light source 1401 is guided by a single mode optical fiber 1402 and caused to be incident on a fiber optical coupler 1403. The light incident from the fiber 1402 is branched to two output fibers by the fiber optical coupler 1403. One of the output fibers is connected to a fundus imaging optical system as a signal light path of the Mach-Zehnder interferometer, and the other output fiber is connected to a reference light path of the interferometer.

In the signal light path, after light outgoing from a fiber end passes through an optical circulator 1404a, it is converted to parallel light by a collimate lens 1405a, transferred in a space, and incident on an XY scanner 1406. The XY scanner 1406 is a reflection type optical scanning device for controlling a two-dimensional reflection angle, and reflected signal light is guided by a scanning lens 1407 and an eyepiece 1408 and incident on an eye 1409. The signal light, which is parallel, is focused on a fundus observation target portion 1410 by a scanning optical system composed of the XY scanner 1406, the scanning lens 1407, and the eyepiece 1408 including an optical action of eyes. The position of the fundus observation target portion 1410 is two-dimensionally scanned on a surface approximately vertical to an optical axis on a fundus. A focus position in a depth direction is adjusted by the eyepiece 1408.

A scan control and a focus control are integrally performed together with other controls by the XY scanner 1406 and a control/signal processing unit 1501 to which a focus drive actuator 1411 is connected. The signal light, which travels in a reverse direction passing through an approximately the same light path, of reflected light and back-scattered light from the fundus observation target portion 1410 is incident on a fiber optical coupler 1414 after it passes through the optical circulator 1404a through the collimate lens 1405a again.

In contrast, after the reference light is branched by the fiber optical coupler 1403 and passes through an optical circulator 1404b, it is converted to parallel light by a collimate lens 1405b and reflected by a reference light mirror 1412 installed on a light delay driver 1413 so that it travels in its light path in a reverse direction. The position of the reference light mirror 1412 is determined such that the total length of the reference light path is reciprocatingly scanned in a predetermined range using the signal light path as a reference by controlling the light delay driver 1413.

The light delay driver 1413 is connected to a control/signal processing unit 1501 and integrally controlled together with other controls. After the reference light that travels in the reverse direction passes through the optical circulator 1404b again through the collimate lens 1405b, it is incident on the fiber optical coupler 1414.

The signal light and the reference light incident on the fiber optical coupler 1414 are branched to a ratio of 50:50, respectively, separated to components traveling to two photoelectric detectors 1415, and transferred in fibers. Each of the fibers is composed of a single mode fiber. Since the signal light and the reference light have the same transfer mode in the fibers, they are superposed with each other and cause optical interference. Optical interference signals are converted to electric signals by the photoelectric detectors 1415 and transmitted to control/signal processing units 1501.

Next, an arrangement and an operation of the control/signal processing units 1501 will be described with reference to FIG. 16.

The control/signal processing units 1501 control the XY scanner 1406, the light delay driver 1413, a focus driver 1411, and the photoelectric detectors 1415, respectively and are provided with drivers and capture units for receiving signals which detect an angle, a position, and an optical signal.

An electric circuit is configured such that the electric signals, voltages, from the two photoelectric detectors 1415, are differentially amplified by an amplifier 1502 and constitute a balanced detector in a so-called Heterodyne interferometer. More specifically, this is a detection system for amplifying only interference components in the optical interference signals generated by changing a light delay length by the light delay driver 1413 and suppressing the fluctuations of intensities of the reference light and the signal light, respectively.

After predetermined frequency regions are extracted from the interference components, which are extracted by the differential amplification, by a filter/detector unit 1503, amplitudes are detected and low noise optical interference amplitude signals are obtained. The optical interference signals are digitalized by a digital sampling unit 1504 at a predetermined sampling rate and transmitted to a central processing unit 1505.

The central processing unit 1505 compares digital optical interference signals, which are transmitted time sequentially, with a scanner position signal/synchronization signal from an XY scanner driver 1506, a delay position signal/synchronization signal from a light delay driver 1507 and a focus position signal from a focus driver 1508 so that the optical interference signals are caused to correspond to a position on the fundus observation target portion. Thereafter, the optical interference signals are allocated to each predetermined pixel and made to an image which is displayed on an image display unit 1509.

The central processing unit 1505 further performs a process for calculating tomographic spectral information from the optical interference signals. How the process is performed will be described with reference to FIGS. 17 to 20B.

FIG. 17 is a schematic view showing a spectral information calculation pixel 1602 and a peripheral region 1603 in an OCT tomographic image 1601 determined by the central processing unit 1505. Here, the spectral information calculation pixel indicates a position where a spectrum image is calculated. FIG. 18A is an enlarged view of FIG. 17, and FIG. 18B is a view showing how spectral information calculation pixel 1602 corresponds to an optical interference signal 1604 used for calculating the spectral information.

In FIG. 18B, a region of the interference signal, which region is centered at Z-coordinate z1 corresponding to the spectral information calculation pixel 1602 and has a width δz in a z-direction, is used to calculate the spectral information of the pixel. That is, a portion corresponding to the region is cut out from the optical interference signal 1604 and used for the calculation. The cut-out portion can be obtained by disposing a window function shown in FIG. 19 to z1 which is the Z-position of the pixel and multiplying it.

Next, the cut-out portion is subjected to the Fourier transformation. This is an arithmetic process called the Short Time Fourier transformation (STFT). including a cut-out portion. Components after the Fourier transformation as described above show how much respective wavelength width components are included in a light source and the optical interference signals as shown in a right below view of FIG. 19. This is because the cycle of the oscillation in the interference signal when changing the light delay, is determined by a difference between light path lengths of delays normalized by the light wavelength and thus optical interference signals having a high frequency component can be obtained in a short wavelength and optical interference signals having a low frequency component can be obtained in a long wavelength.

A left below graph of FIG. 19 shows a comparison of the light wavelength components obtained by the Fourier transformation with an original spectrum of the light source. It is found that attenuation occurs in longer wavelengths, λ3 and λ4, in the example. Thus, an optical spectrum can be obtained at the optional position z1. As shown in FIG. 20A, to create an image from the optical spectrum, it is possible to determine a center of gravity λg of the optical spectrum and uses it as a single index. The example shows λg corresponding to a pixel position (x1, z1). An image, in which the center of gravity of the optical spectrum is allocated to the respective pixels of an x-z cross-sectional image (so-called B-scan image), can be formed by repeating the arithmetic operation to the other pixels (x, z) as described above. Patent Document 1 discloses an example in which both of a morphology image and a spectrum image are shown in optical tomography by the above method and used for diagnosis.

### CITATION LIST

### Patent Literature

PTL1: Japanese Patent Application Laid-Open No. 2002-172117

### Non Patent Literature

NPL1: Optics Letters Vol. 25, No. 2 (2000) pp. 111-113

### SUMMARY OF THE INVENTION

However, the OCT device described above has a problem in that if the accuracy of position is increased when obtaining tomographic spectral information at a certain position in a tomographic image, the accuracy of the spectral information will be decreased.

For example, in the above example, tomographic spectral information at the depth position z1 in FIG. 19 is created based on the optical interference signals having the width δz. A specification of a typical spectrum OCT is such that a light source has a wavelength width of 150 nm and a depth resolution in a corresponding living body, that is, a size of a depth pixel is about 1 μm. Accordingly, an intrinsic spectrum OCT preferably obtains tomographic spectral information by setting δz to a width as large as a pixel.

However, it is known from a restriction in principle based on the Fourier transformation that a product of the resolution δz in a depth direction and the accuracy δν of the tomographic spectral information have an upper limit. Here, ν is an optical frequency, and ν=c/λ (c is a light velocity).

The product is known to have constraint of δz·δν≧c/4π. Representing a wavelength accuracy δλ=δν·λ/ν, and assuming a living body where the light wavelength is 0.8 μm, the product δz·δν is shown to have a minimum value of about 70 μm·nm. That is, when δz is 1 μm, spectrum accuracy δλ becomes about 70 nm, and its uncertainty is increased to about half the wavelength width of 150 nm of the light source.

In contrast, tomographic spectral information used in an example of a typical spectrum OCT has δz set from about 50 μm to 200 μm, and, in this case, the spectrum accuracy δλ is better than 2 nm. Although this value is sufficient as the spectrum accuracy, it is insufficient for tomography, since the target for obtaining tomographic spectral information, for example a blood capillary, has a structure of 5 μm to 10 μm. Also the position accuracy δλ is insufficient for observing a dyed cell three-dimensionally.

As described above, the conventional spectrum OCT device has a problem in that it cannot realize a device capable of outputting tomographic spectral information corresponding to a fine tomography structure with high wavelength accuracy.

An object of the present invention, which was made to solve the above problems, is to provide an optical coherence tomographic imaging apparatus capable of outputting tomographic spectral information corresponding to an optical coherence tomographic image with high wavelength accuracy.

To achieve the above object, there is provided an optical coherence tomographic imaging apparatus for splitting light emitted from a light source into reference light and signal light and creating an optical coherence tomographic image and tomographic spectral information in a predetermined spectral analyzing portion in the optical coherence tomographic image base on optical interference signal information of the reference light and the signal light which are incident on an inspection target and reflected on respective layers, the optical coherence tomographic imaging apparatus comprising a spectral information processing unit which performs a spectral information calculation using an optical interference signal of a deeper region, which is positioned deeper than the spectral analyzing portion with respect to a light emitting direction, to create the tomographic spectral information of the spectral analyzing portion.

### ADVANTAGEOUS EFFECT OF INVENTION

The present invention realizes an optical coherence tomographic imaging apparatus capable of outputting tomographic spectral information corresponding to an optical coherence tomographic image with high wavelength accuracy.

### BRIEF DESCRIPTION OF DRAWINGS

FIG. 1 is a schematic view showing function blocks of an optical coherence tomographic imaging apparatus according to a first embodiment of the present invention.

FIG. 2 is a schematic view showing an arrangement of an optical measuring system of the optical coherence tomographic imaging apparatus according to the first embodiment of the present invention.

FIG. 3 is a schematic view showing function blocks of a control/signal processing unit of FIG. 2.

FIG. 4 is a schematic view showing an aspect of designating a spectral analyzing region of the optical coherence tomographic imaging apparatus according to the first embodiment of the present invention.

FIG. 5A is a schematic view showing an aspect of designating a spectral analyzing region according to the first embodiment of the present invention.

FIG. 5B is a schematic view showing an aspect of designating a shadow region according to the first embodiment of the present invention.

FIG. 6 is a schematic view showing function blocks of a spectral information processing unit according to the first embodiment of the present invention.

FIG. 7A is a schematic view showing an optical spectral signal obtained from the shadow region according to the first embodiment of the present invention.

FIG. 7B is a schematic view showing a standardized optical spectrum obtained by normalizing the optical spectral signal obtained from the shadow region according to the first embodiment of the present invention by a spectrum of a light source.

FIG. 7C is a schematic view showing a spectrum of an analyzing portion according to the first embodiment of the present invention.

FIG. 8 is a schematic view showing an example of an image displayed by the optical coherence tomographic imaging apparatus according to the first embodiment of the present invention.

FIG. 9 is a schematic view showing another example of the image displayed by the optical coherence tomographic imaging apparatus according to the first embodiment of the present invention.

FIG. 10 is a schematic view showing still another example of the image displayed by the optical coherence tomographic imaging apparatus according to the first embodiment of the present invention.

FIG. 11A is a schematic view showing an aspect of designating a shadow region of an optical coherence tomographic imaging apparatus according to a second embodiment of the present invention.

FIG. 11B is a schematic view showing an aspect of designating an extended region of the optical coherence tomographic imaging apparatus according to the second embodiment of the present invention.

FIG. 12A is a schematic view showing optical spectral signals obtained from the shadow region and the extended region of the second embodiment according to the present invention.

FIG. 12B is a schematic view showing a normalized spectrum obtained by normalizing an optical spectral signal obtained from the shadow region according to the second embodiment of the present invention by an optical spectrum obtained from the extended region.

FIG. 12C is a schematic view showing a spectrum of an analyzing portion according to the second embodiment of the present invention.

FIG. 13A is a schematic view showing another example of designating a shadow region to a blood vessel according to the second embodiment of the present invention.

FIG. 13B is a schematic view showing another example of designating an extended region to the blood vessel according to the second embodiment of the present invention.

FIG. 13C is a schematic view showing still another example of designating the extended region to the blood vessel according to the second embodiment of the present invention.

FIG. 14 is a schematic view showing function blocks of a modification of the embodiments of the present invention.

FIG. 15 is a schematic view showing an arrangement of an optical measuring system of an optical coherence tomographic imaging apparatus in a conventional technique.

FIG. 16 is a schematic view showing function blocks of a control/signal processing unit in the conventional technique.

FIG. 17 is a schematic view showing an aspect of designating a spectral analyzing region designation in the conventional technique.

FIG. 18A is a schematic view showing a region designation in the conventional technique.

FIG. 18B is a schematic view showing an optical interference signal corresponding to a designated region in the conventional technique.

FIG. 19 is a schematic view showing an outline of a Fourier transformation and spectral information processing in the conventional technique.

FIG. 20A is a schematic view showing an example of the spectral information processing in the conventional technique.

FIG. 20B is a schematic view showing an example of the spectral information processing in the conventional technique.

### DESCRIPTION OF EMBODIMENTS

The present invention will be described below based on illustrated examples in detail.

### First Embodiment

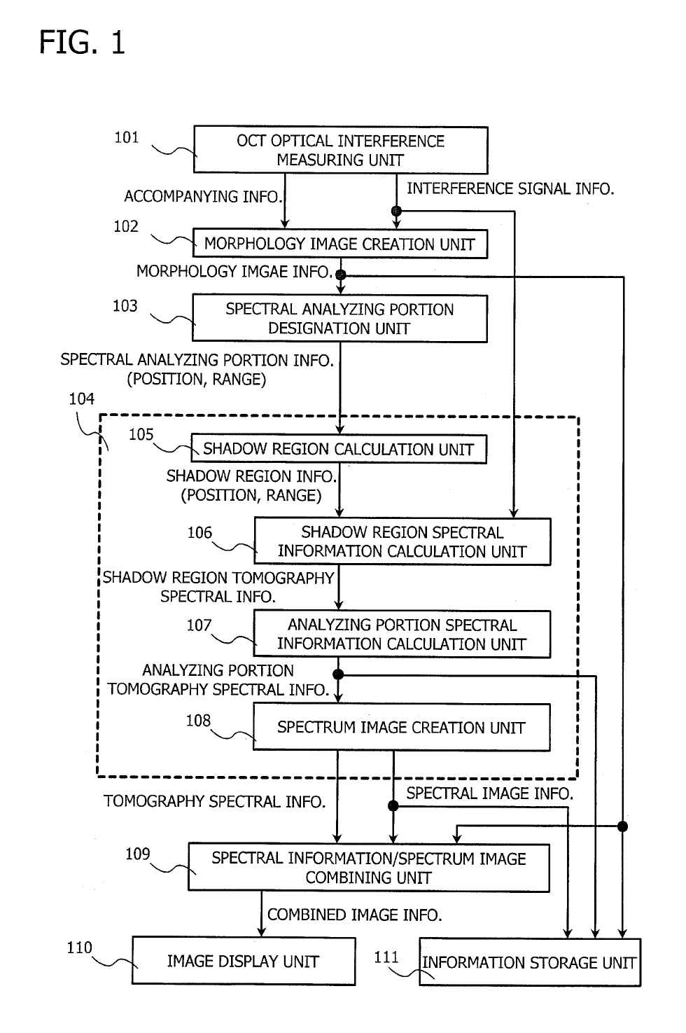

FIG. 1 is a function block diagram schematically showing an optical coherence tomographic imaging apparatus according to an embodiment of the present invention.

The optical coherence tomographic imaging apparatus has an OCT optical coherence measuring unit 101 for measuring an optical interference signal and a morphology image creation unit 102 for creating an optical coherence tomographic image based on the information.

The OCT optical interference measuring unit 101 obtains, creates, and outputs optical interference signal information and its accompanying information, i.e. position information (a tomography depth direction and a direction orthogonal to the tomography depth direction). That is, the OCT optical interference measuring unit 101 branches illumination light outgoing from a light source to reference light and signal light and obtains the optical interference signal information by combining the reference light and the signal light which is incident in an inspection target and reflected on respective layers.

The optical coherence tomographic imaging apparatus further has a spectral analyzing portion designation unit 103 for designating a position and a range of a spectral analyzing portion in an optical coherence tomographic image and a spectral information processing unit 104 for creating tomographic spectral information of a designated spectral analyzing portion.

The analyzing portion designation unit 103 discriminates which portion of the morphology image is to be calculated, and outputs it as spectral analyzing portion information. Further, the information is transmitted to an information storage unit 111 so that it is stored therein.

The spectral information processing unit 104 calculates spectral information by an optical interference signal of a deeper region (shadow region) positioned deeper than the analyzing portion in terms of the light radiating direction and creates tomographic spectral information of the spectral analyzing portion.

The spectral information processing unit 104 has a shadow region calculation unit 105 as a deeper region calculation means and a shadow region spectral information calculation unit 106 as a deeper region spectral information calculation means. Further, the spectral information processing unit 104 has an analyzing portion spectral information calculation unit 107 as an analyzing portion spectral information calculation means and a spectrum image creation unit 108 as a spectrum image creation means.

The spectral analyzing portion information transmitted from the spectral analyzing portion designation unit 103, that is, information for designating the position and the range of the spectral analyzing portion in a morphology image is first input to the shadow region calculation unit 105. The shadow region calculation unit 105 specifies a position and a range of a shadow region corresponding, to the input spectral analyzing portion and outputs shadow region information as deeper region information.

Next, the shadow region spectral information calculation unit 106 calculates and outputs tomographic spectral information corresponding to the shadow region. The tomographic spectral information of the shadow region is appropriately converted to tomographic spectral information of the original portion to which a shadow corresponds by the analyzing portion spectral information calculation unit 107 and output as tomographic spectral information of the analyzing portion.

When a plurality of the spectral analyzing portions are given, the spectral information processing unit 104 repeats the above processing to the spectral analyzing portions and outputs tomographic spectral information of the respective portions, that is, a plurality of tomographic spectral information.

The tomographic spectral information is transmitted to the information storage unit 111 so that it is stored therein, whereas it is transmitted to the spectrum image creation unit 108 and subjected to an image creation processing so that the tomographic spectral information is displayed as an image on an optical coherence tomographic image. After both the tomographic spectral information as a THROUGH signal and spectrum image information created based on the tomographic spectral information are appropriately combined by a spectral information/spectrum image combining unit 109, they are transmitted to an image display unit 110 and appropriately displayed in response to a designation of a user and the like. The spectrum image information is transmitted to the information storage unit 111 and stored therein.

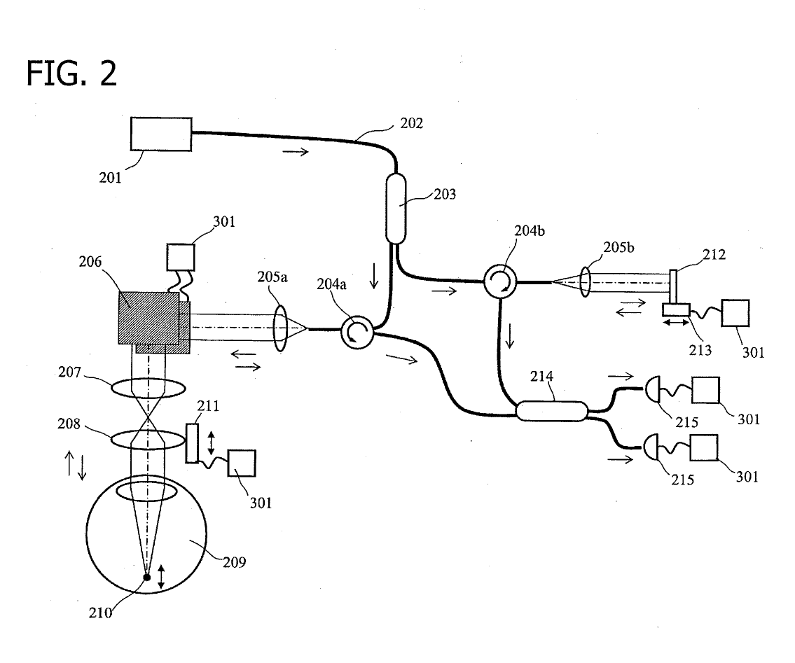

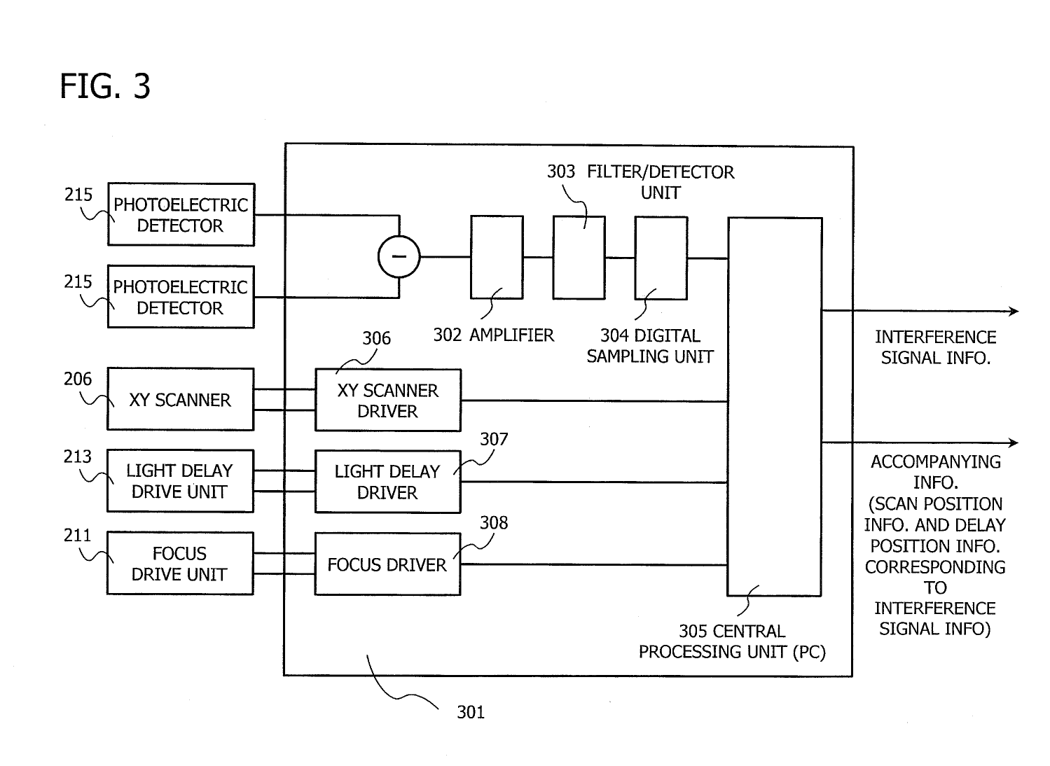

The respective means will be described below in detail. First, an arrangement of the OCT optical interference measuring unit 101 will be described in detail with reference to FIGS. 2 and 3.

The OCT optical interference measuring unit 101 has a light source 201 for emitting low coherent light, a fiber optical coupler 203 for splitting the emitted light to reference light and signal light, and an optical fiber 202 for connecting the light source 201 and the fiber optical coupler 203 (refer to FIG. 2).

In FIG. 2, the light emitted from the light source 201 is guided by a single mode optical fiber 202 and incident on the fiber optical coupler 203. The light incident from the fiber 202 is branched to two output fibers by the fiber optical coupler 203. One of the output fibers is connected to a fundus imaging optical system as a signal light path of a Mach-Zehnder interferometer, and the other output fiber is connected to a reference light path of the interferometer.

An optical circulator 204a, a collimate lens 205a for converting the signal light to a parallel light, an XY scanner 206 constituting an optical scan device for scanning the signal light, a scanning lens 207, and an eye lens 208 are disposed in the signal light path.

After the light outgoing from a fiber end of the optical fiber 202 passes through the optical circulator 204a, it is converted to the parallel light by the collimate lens 205a, transferred in a space and incident on the XY scanner 206. The XY scanner 206 is a reflection type optical scanning device for controlling a two-dimensional reflection angle, and a reflected signal light is guided by the scanning lens 207 and the eyepiece 208, and incident on an eye 209.

The signal light, which is parallel, is focused on a fundus observation target portion 210 by the scanning optical system composed of the XY scanner 206, the scanning lens 207, and the eyepiece 208 including an optical action of eyes. In addition, the position of the fundus observation target portion 210 is two dimensionally-scanned on a plane approximately vertical to an optical axis on a fundus, and a focus position in the depth direction is adjusted by the eyepiece 208.

A scan control and a focus control are integrally performed together with other controls by control/signal processing units 301 to which the XY scanner 206 and a focus drive actuator 211 are connected. The signal light, which travels in a reverse direction passing through an approximately the same light path, of reflected light and back-scattered light from the fundus observation target portion 210 is incident on a fiber optical coupler 214 after it passes through the optical circulator 204a through the collimate lens 205a again.

In contrast, an optical circulator 204b, a collimate lens 205b for converting the reference light to the parallel light, and a reference light mirror 212 for reflecting the reference light so that it travels in a light path thereof in a reverse direction are disposed to the light path of the reference light branched by the fiber optical coupler 203. The reference light mirror 212 is disposed on a light delay driver 213, and a total length of the reference light path can be controlled by controlling the light delay driver 213.

After the reference light passes through the optical circulator 204b, it is converted to the parallel light by the collimate lens 205b and reflected by the reference light mirror 212 disposed on the light delay driver 213 so that it travels in the light path in the reverse direction. The position of the reference light mirror 212 is determined such that the total length of the reference light path is reciprocatingly scanned in a predetermined range using the signal light path as a reference by controlling the light delay driver 213.

The light delay driver 213 is connected to control/signal processing units 301 and integrally controlled together with other controls. After the reference light that travels in the reverse direction passes through the optical circulator 204b again through the collimate lens 205b, it is incident on the fiber optical coupler 214.

The signal light and the reference light incident on the fiber optical coupler 214 are branched to a ratio of 50:50, respectively, separated to components traveling two photoelectric detectors 215, and transferred in fibers. Each of the fibers is composed of a single mode fiber. Since the signal light and the reference light have the same transfer mode in the fibers, they are superposed with each other and cause optical interference. Optical interference signals are converted to electric signals by photoelectric detectors 215 and transmitted to control/signal processing units 301.

Next, an arrangement and an operation of the control/signal processing unit 301 will be described with reference to FIG. 3.

The control/signal processing units 301 control the XY scanner 206, the light delay driver 213, a focus driver 211, and the photoelectric detectors 215, respectively and is provided with drivers and capture units 306, 307, 308 for receiving signals which detect an angle, a position, and an optical signal.

An electrical circuit is arranged such that the electric signals, voltage, from the two photoelectric detectors 215, are differentially amplified by an amplifier 302 and constitutes a balanced detector in a so-called Heterodyne interferometer. More specifically, this is a detection system for amplifying only interference components in the optical interference signals generated by changing a light delay length by the light delay driver 213 and suppressing the fluctuations of intensities of the reference light and the signal light, respectively. After predetermined frequency regions are extracted from the interference components, which are extracted by the differential amplification, by a filter/detector unit 303, amplitudes are detected and low noise optical interference amplitude signals are obtained. The optical interference signals are digitalized by a digital sampling unit 304 at a predetermined sampling rate and transmitted to a central processing unit 305.

The central processing unit 305 compares digital optical interference signals, which are transmitted time sequentially, with a scanner position signal/synchronization signal from an XY scanner driver 306, a delay position signal/synchronization signal from a light delay driver 307 and a focus position signal from a focus driver 308 so that the optical interference signals are caused to correspond to a position on the fundus observation target portion.

Thereafter, the optical interference signals are allocated to every predetermined pixel. As a result, interference signal information and accompanying information to which the interference signal information is associated are output. The accompanying information includes, for example, XY scanner scanning position information, light delay position information, pixel position information which is arranged as a coordinate based on the light delay position information, and the like.

The morphology image creation unit 102 of FIG. 1 creates a morphology image of a tomography section as an optical coherence tomographic image based on the interference signal information and the accompanying information, and the morphology image information is transferred to the information storage unit 111 and the spectral information/spectrum image combining unit 109. The optical coherence tomographic image is created as described below. That is, first, interference signals digitally sampled at predetermined sampling intervals are made to complex interference signals by the Hilbert transformation at respective sampling points. After amplitude components are taken out from the complex interference signals and subjected to a logarithmic transformation, they are made to an image together with the position information as the accompanying information and thus the optical coherence tomographic image is created.

In the embodiment, since the light source 201 has a wavelength width of about 150 nm and a depth resolution of about 1 μm, pixels have a depth-directional size of 1 μm in view of the above sizes. Further, an optical spot size on a fundus determined by the scanning optical system and an action of eyes is about 5 μm, and a pixel size in a scan direction is set to 5 μm accordingly. Amplitude values of the sampling points corresponding to one pixel region are averaged and made to one amplitude value corresponding to one pixel and arranged as an image.

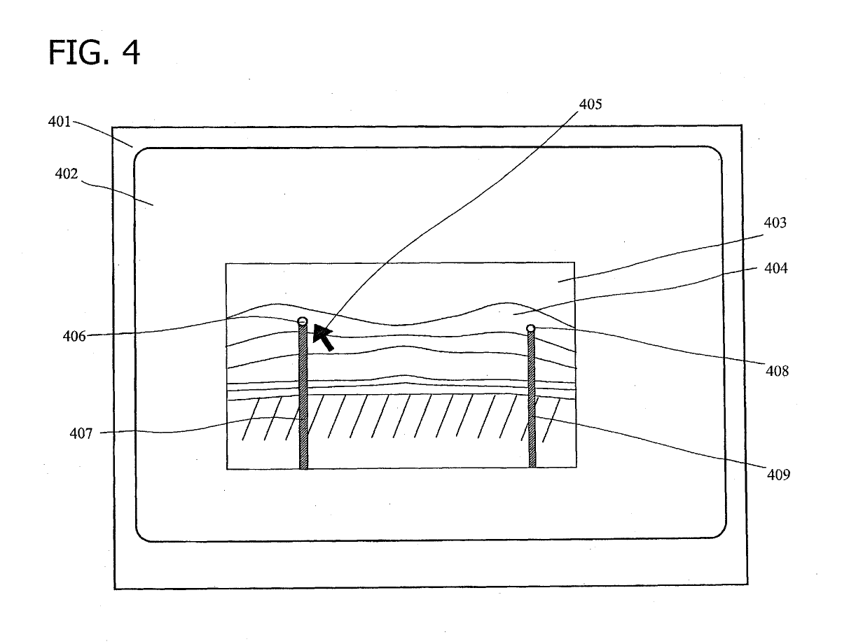

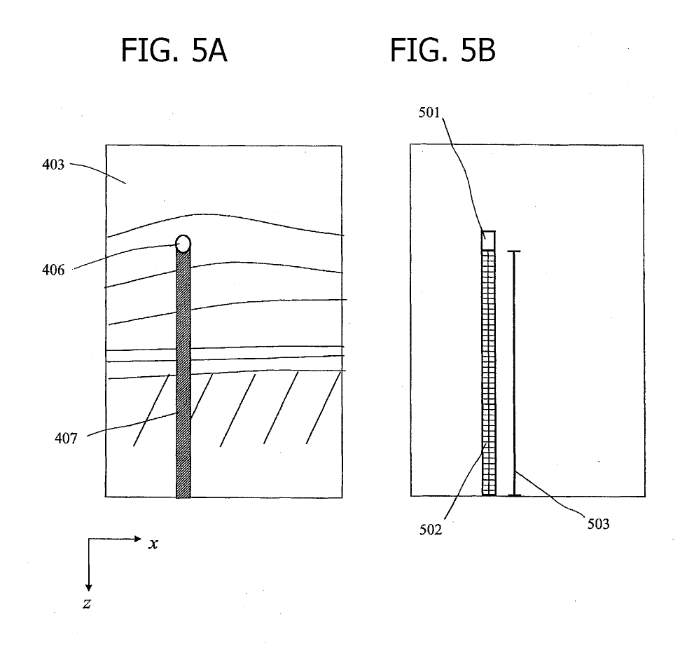

Next, the spectral analyzing portion designation unit 103 of FIG. 1 will be specifically described with reference to FIGS. 4, 5A, and 5B.

In FIG. 4, an optical coherence tomographic image 403 as a morphology image is displayed on a screen 402 of a monitor 401 which is a specific arrangement of the image display unit 110, and a retina tomographic image 404 is drawn in the image. A pointer cursor 405 is displayed on the screen 402, and a user can designates and inputs a position of the pointer cursor 405 by a mouse, a touch pad, and the like. In the embodiment, a blood capillary portion 406 as a high luminance portion that is drawn in the image is a spectral analyzing portion, and the user designates the blood capillary portion 406 by drawing a figure by the pointer cursor 405 so as to surround the region thereof.

Note that a shadow 407 as a deeper region appears as a low luminance portion under the blood capillary portion 406 as the high luminance portion. Likewise, the user also designates an analyzing portion as to a different blood capillary portion 408.

Note that the designation can be automatically or semi-automatically performed and further a manual mode, an automatic mode, and a semi-automatic mode can be also switched. In the automatic mode, the high luminance portion of the optical coherence tomographic image 403 can be automatically discriminated using a so-called segmentation technique based on not only a simple luminance but also a shape and a characteristic amount thereof, thereby the input is automated. In the semi-automatic input mode, after the user displays the analyzing portion once, he or she can input a designation for confirmation, correction, and the like.

Further, the input analyzing portion designating information as shown FIG. 5A is caused to correspond to pixels as shown in FIG. 5B. That is, since a region designated by being drawn is generally a region surrounded by a curved line, a region 501 of a pixels unit included in the region is subjected to a calculation processing including a discrimination of a boundary region. Although the boundary is simply discriminated by a threshold value based on an area ratio of the inside and the outside of a boundary line, it may be discriminated including an inclusion relation of peripheral pixels in addition to the above discrimination. The semi-automatic mode, in which the user makes a decision according to necessary, may be provided.

In the embodiment, a region of 10 μm×10 μm, that is, 2 pixels (1 pixel: 5 μm×2 pixels=10 μm) in an x-direction and 10 pixels (1 pixel 1 μm×10 pixels=10 μm) in the z-direction is discriminated as the spectral analyzing portion 501 in FIG. 5B.

The shadow region calculation unit 105 of FIG. 1 discriminates and designates a shadow region 502 corresponding to the spectral analyzing portion 501. The embodiment designates pixels from just under the spectral analyzing portion 501 to the lowest end as the shadow region 502. Reference numeral 503 in FIG. 5B shows a depth range of the shadow region.

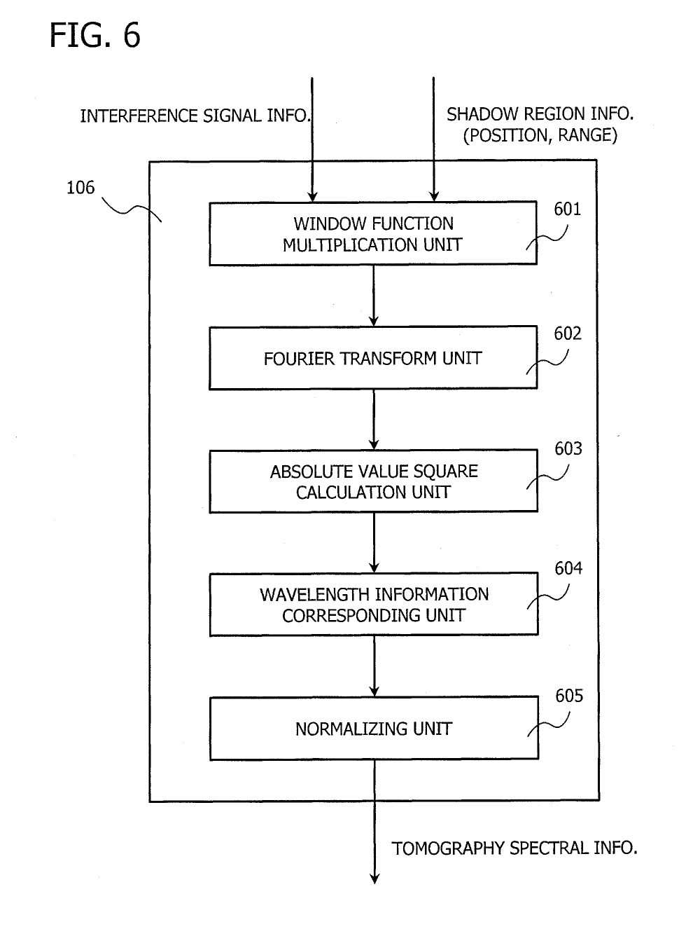

Next, a specific arrangement of the shadow region spectral information calculation unit 106 will be described with reference to FIG. 6. In FIG. 6, a window function multiplication unit 601 multiplies a window function corresponding to the shadow region depth range 503 of the shadow region to a digitally sampled an interference signal. In the embodiment, a rectangular function is used as the window function which is a function having a value of 1 inside of the shadow region depth range and a value of 0 outside thereof.

After the interference signal is multiplied by the window function, it is converted between a time axis and a light wave number axis by the Fourier transform unit 602, thereby a complex function of interference amplitude to a light wave number can be obtained. Next, a square of an absolute value of the complex function is calculated by an absolute value square calculation unit 603. Further, spectral information as a function of a light wavelength can be obtained by a wavelength information corresponding unit 604 for correcting an inverse number relation between the light wave number and the light wavelength.

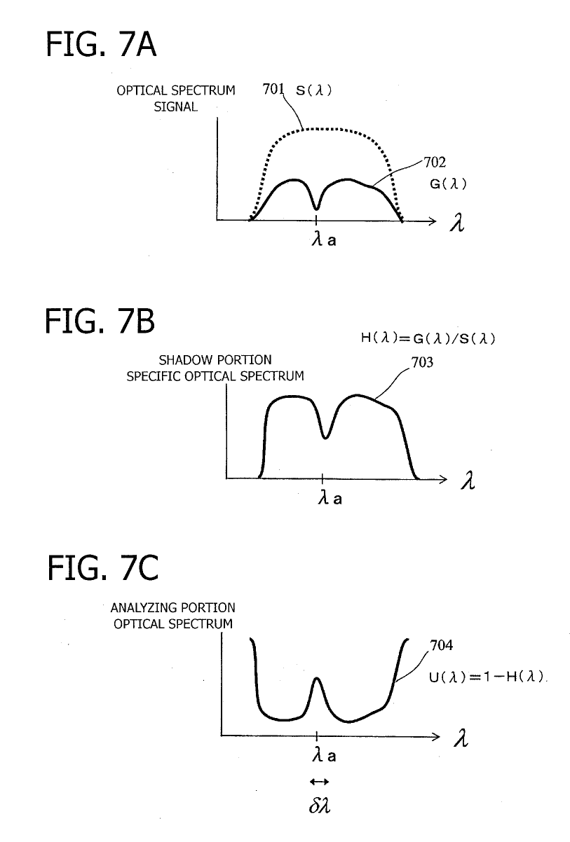

FIG. 7A shows an optical spectral signal 702 of a shadow region as a result of the above-mentioned calculation together with an optical spectrum 701 of the light source. The blood capillary portion 406 shown with high luminance in the OCT image of FIG. 5A, has such a property that a spectral reflectance is high in the vicinity of a specific peak wavelength λa as to the components of a blood vessel and a blood flow, and thus intensity in a light wavelength in the vicinity of λa which is lost by reflection is lowered in a shadow portion.

Subsequently, a standardization unit 605 is input with S(λ) as an optical spectrum 701 of the light source and G(λ) as an optical spectrum 702 of the shadow region from a not shown storage means and obtains a standardized optical spectrum H(λ), which is defined by H(λ)=G(λ)/S(λ), as an output. This is shown in FIG. 7B (703).

Next, the analyzing portion spectral information calculation unit 107 calculates the optical spectrum of the analyzing portion from the shadow region spectral information as spectral information. The optical spectrum of U(λ) of the analyzing portion is defined by U(λ)=1−H(λ), and FIG. 7C shows an optical spectrum 704 of the analyzing portion obtained by the calculation.

In the optical spectrum shown in FIGS. 7A to 7C, a wavelength accuracy δλ, which shows a change in the vicinity of a characteristic wavelength λa, is not determined by a depth range of a region of the analyzing portion and is determined by a depth range of an overall shadow region which is larger in the depth direction. Accordingly, since the accuracy is increased particularly when tomographic spectral information of a capillary vessel and a cell structure of a retinal surface are obtained, this is useful.

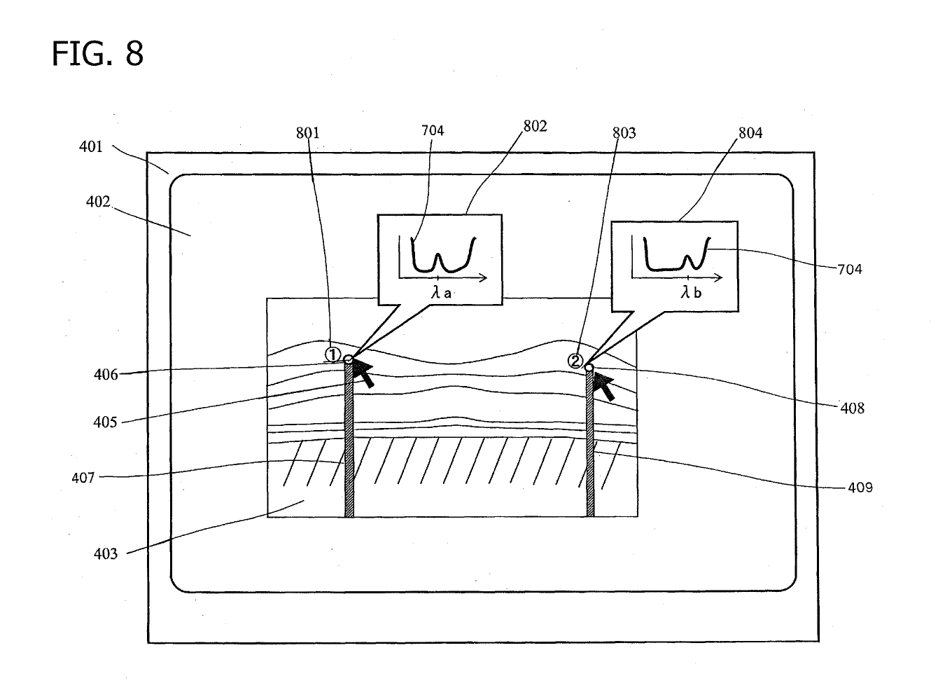

Next, an example of display of an image combined by the spectral information/spectrum image combining unit 109 and the image display unit 110 of the embodiment will be described referring to FIG. 8.

In FIG. 8, an analyzing portion sign 801 is shown in the optical coherence tomographic image 403. The sign is discriminated by a numeral, and the blood capillary portion 406 as a corresponding spectral analyzing portion is highlighted in the vicinity of the numeral.

When the pointer cursor 905 is moved to the vicinity of the highlighted portion by an operation of the user, a blow-out 802 is newly displayed in an overlapping state. A graph of the analyzing portion optical spectrum 704 is displayed in the blow-out 802 as the tomographic spectral information shown in FIG. 7C. FIG. 8 also schematically shows an image at a different time when the pointer cursor 405 is moved to the vicinity of a second analyzing portion 803. In this case, the blow-out 802 disappears and a blow-out 804 is newly displayed, and a graph of the analyzing portion optical spectrum corresponding to the second analyzing portion 803 is displayed in the blow-out 804.

The highlight display of the blood capillary portion 406, the analyzing portion sign 801, the blow-outs 802 and 804 are the spectrum image information and created by the spectrum image creation unit 108. The analyzing portion optical spectrum 704, which is the spectrum image information, and the tomographic spectral information, are combined by the spectral information/spectrum image combining unit 109 and overlap-displayed on an optical coherence tomographic image of the image display unit 110 as synthesized image information.

In the present invention, an OCT probe which includes fine particles having a nanostructure of gold (Au) with a targeting function, for example, can be used as a fundus contrast medium. The fine gold particles are used to increase a reflectance of a specific portion so that a luminance of the portion is increased as OCT. At the same time, a spectral reflectance having a peak in the vicinity of a specific wavelength can be obtained by preparing a size and a shape of the nanostructure and previously controlling a resonance wavelength of a surface plasmon as a metal.

When a plurality of the OCT probes are used by changing the size and the shape thereof, a plurality of portions can be sorted and drawn by a difference of a spectral reflectance. In, for example, the embodiment, two types of probes can be used to find and identify portions acting as different disease sources in the vicinity of a capillary vessel. A first probe uses fine particles having a gold nanostructure whose spectral reflectance is increased in the vicinity of the wavelength λa and a second probe uses fine particles having a gold nanostructure whose spectral reflectance is increased in the vicinity of a wavelength λb, and molecules each having a different targeting function are synthesized by a so-called thiol bond.

When the two types of the probes are provided and a difference in the two portions shown in, for example, FIG. 8 is detected and displayed by the different probes, it is more preferable to display the types of the probes estimated by an automatic discrimination by a character in addition to the graph of the optical spectrum of the analyzing portion that appears in the blow-out.

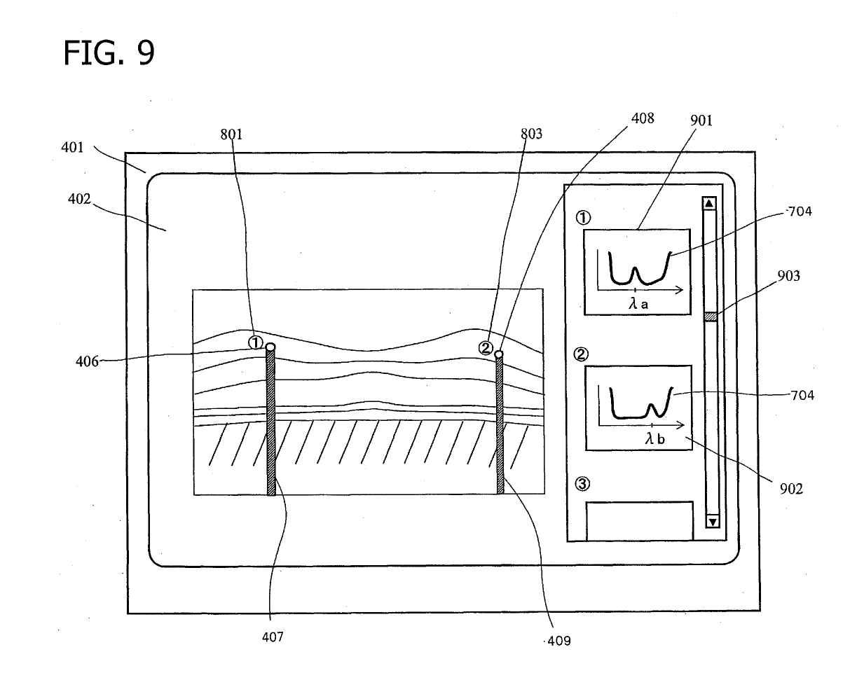

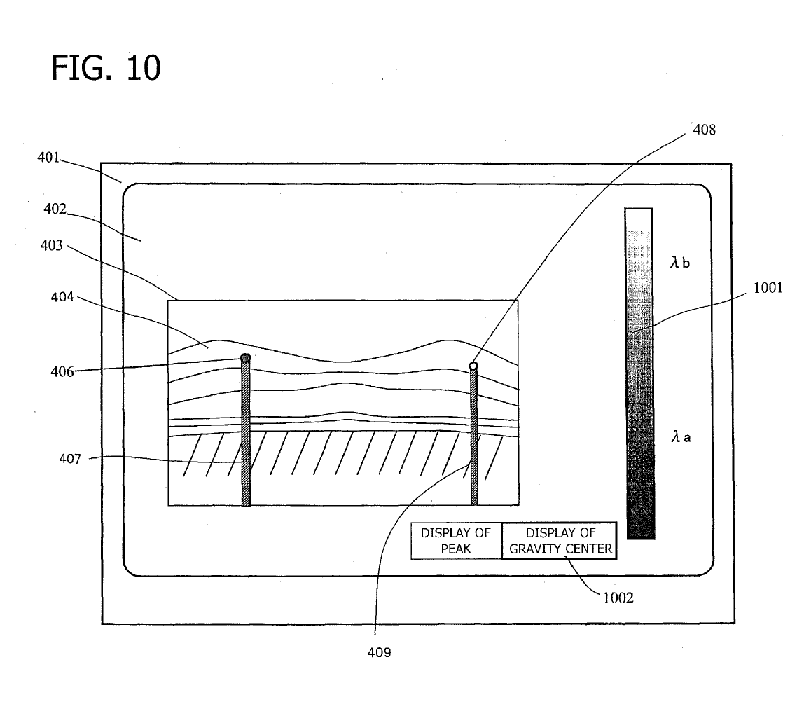

FIGS. 9 and 10 show other display modes of the embodiment.

In the display mode of FIG. 9, tomographic spectral information corresponding to a plurality of analyzing portions is collectively shown at the same time in a right portion of a screen. That is, the tomographic spectral information 901 and 902 corresponding to the blood capillary portion 406 as a first spectral analyzing portion and the blood capillary portion 408 as a second analyzing portion are collectively displayed. Displayed positions of the information can be changed by a designation of the user with a display cursor 903. The display mode is useful particularly when a lot of analyzing portions are treated.

In the display mode shown in FIG. 10, portions corresponding to the peak wavelengths λa and λb are displayed with colors in the morphology image. The color code is displayed in correspondence to the wavelengths in a right portion of the screen. In the display mode, the display color can be determined based on a gravity center wavelength by switching a switch 1002 on a GUI, in addition to the peak wavelengths. Images according to the display modes are created by the spectrum image creation unit 108.

The arrangement of the above embodiment permits realization of an optical coherence tomographic imaging apparatus which can obtain and display tomographic spectral information having a high accuracy as to a fine spectral analyzing portion such as a capillary vessel.

### Second Embodiment

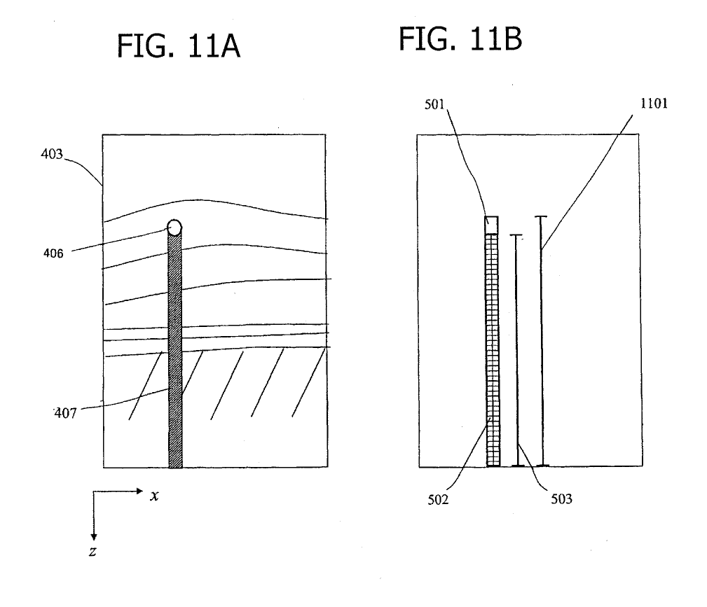

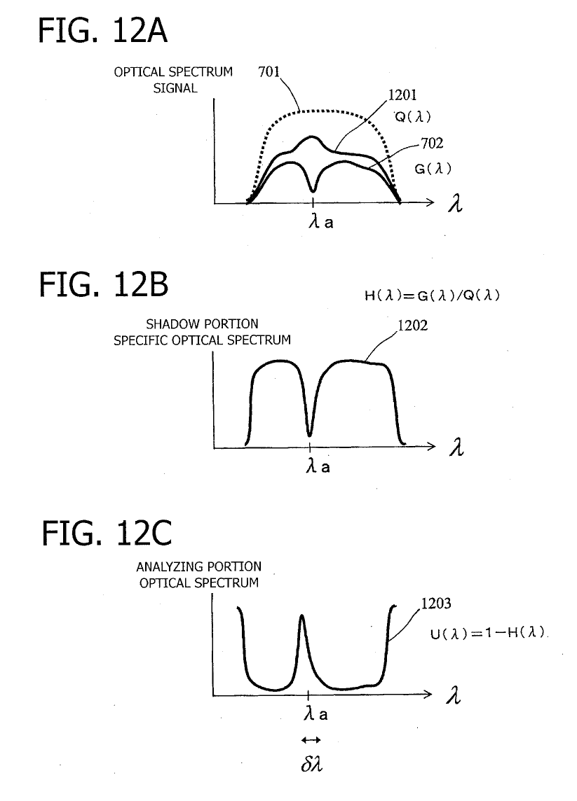

A second embodiment of the present invention will be described below with reference to FIGS. 11A, 11B, and 12A to 12C.

The second embodiment shows an example in which the standardization of the optical spectrum, which is performed by the standardization means of the first embodiment, is modified in order to more increase the accuracy of the optical spectrum in a spectral analyzing portion.

In the second embodiment, when the spectral information processing unit 104 discriminates the shadow region 502 as a deeper region, it further sets an extended region 1101 as shown in FIGS. 11A and 11B. The extended region 1101 is a sum of the shadow region 502 and the spectral analyzing portion 501. In a spectral information calculation as a next step, after a square processing is separately performed by multiplying a window function corresponding to the extended region 1101 to an interference signal in addition to a window function to the shadow region 502, the Fourier transformation and an absolute value square processing are performed to thereby obtain optical spectral information.

As shown in FIGS. 12A to 12C, extended region spectral information 1201 can be obtained in addition to the shadow region spectral information 702. The extended region optical spectral information 1201 is obtained by applying Fourier spectral analysis to interference signals having low reflection component at the shadow region and high reflection component at the analyzing portion. The high reflection of the analyzing portion and the low reflection of the shadow region have components which are cancelled with each other. However, since the high reflection component exceeds the low reflection component in total, the spectral reflectance of the expansion region optical spectrum 1201 takes larger value at the peak wavelengths than at other wavelengths (FIG. 12A).

Next, G(λ), which is the optical spectrum 702 of a shadow region, is obtained by calculating a standardized optical spectrum H(λ) defined by H(λ)=G(λ)/Q(λ) by Q(λ) as the expansion region optical spectrum 1201 (FIG. 12B).

Subsequently, an optical spectrum U(λ) as analyzing portion tomographic spectral information is output by calculating U(λ)=1−H(λ) (FIG. 12C).

FIGS. 12B and 12C show a result of the calculation, respectively. A spectrum whose spectral characteristics are emphasized can be obtained as compared with standardization performed by the optical spectrum of the light source. In addition, an influence of spectral characteristics from the light source to an analyzing portion through a system can be reduced.

As described above, although a processing load of the system is increased by the embodiment, tomographic spectral information can be more accurately obtained and displayed.

### Other Embodiments

It is needless to say that the present invention is by no means limited to the specific arrangements described in the respective embodiments and a part of components can be used by being modified within a range which does not depart from the present invention.

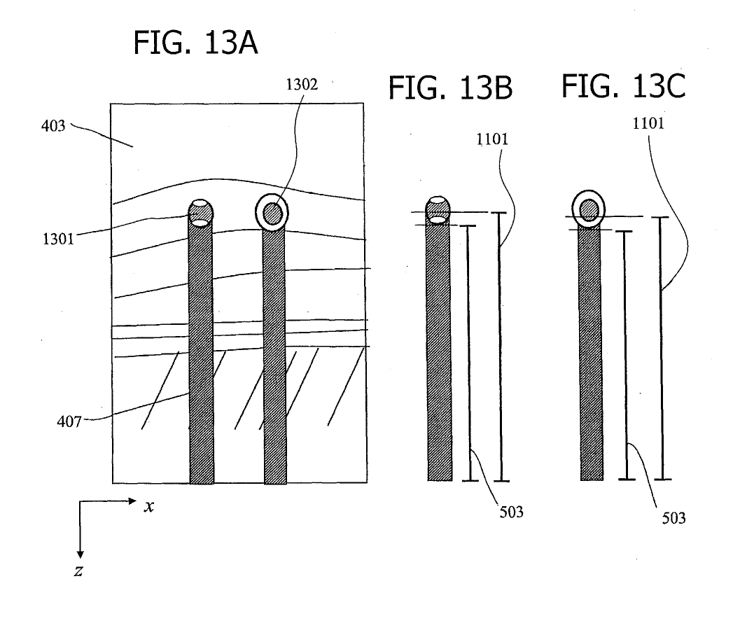

For example, when a blood vessel lager than a capillary vessel is used as an spectral analyzing portion in the second embodiment, that is, when a structure, in which a blood vessel wall drawn as a high reflection layer in a morphology image is separated across a blood flow, is used as a spectral analyzing portion, it is preferable to set an expansion region as shown in FIGS. 13A to 13C.

That is, portions under blood vessels 1301 and 1302 drawn out separately in a morphology image are selected as high reflection regions of the embodiment and the expansion region 1101 is set thereto. In other words, the expansion region 1101 is set such that it includes a lower portion of the blood vessel wall, and it does not include a blood flow region located on the lower portion of the blood vessel wall as much as possible. When the expansion region is set as described above, an influence of spectrum absorption due to the blood flow is collectively captured to a calculation as spectral reflection information of a high reflection region of the lower portion of the blood vessel wall. As a result, spectral characteristics of a blood flow can be more accurately obtained as compared with a case in which an overall blood vessel including an upper portion of the blood vessel wall is included in the expansion region.

Regions of the thick blood vessels 1301 and 1302 may be manually designated, and regions according to a segmentation of a blood vessel from a morphology image and to a thickness of a blood vessel are preferably semi-automatically or automatically designated by previously registering the regions as an automatic algorithm.

Further, the high luminance portion is selected as the spectral analyzing portion in the embodiments, and the spectral analyzing portion may be the low luminance portion. In this case, since the portion is made to a low luminance by a spectral absorption in place of a spectral reflection and a corresponding shadow portion is formed, an optical absorption spectrum is accurately detected from the shadow portion expanding in the depth direction. In this case, a specific tissue, cell, and the like may be targeted using a molecular probe pigment and the like having a strong absorption in the vicinity of a specific wavelength.

The optical coherence measuring unit used in the embodiments is arranged as the Mach-Zehnder interferometer, and it may be arranged as the Michelson interferometer and other interferometer. Further, the arrangement of the time domain OCT is used in the respective embodiments, and a Fourier domain OCT may be used. In this case, a spectral information processing similar to that of the time domain OCT can be performed by obtaining a interference signal by the inverse Fourier transformation and the like as known well.

Further, the embodiments are arranged by the time domain OCT of a so-called A-scan priority scan by scanning a delay line, and they may be arranged by a lateral scan priority time domain OCT provided with an external modulator.

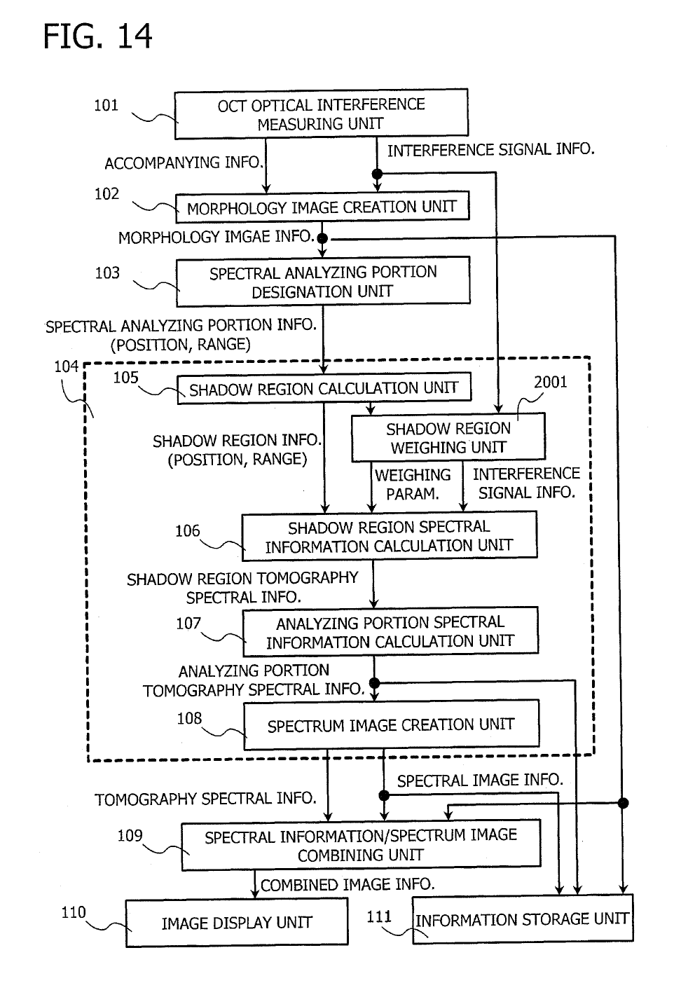

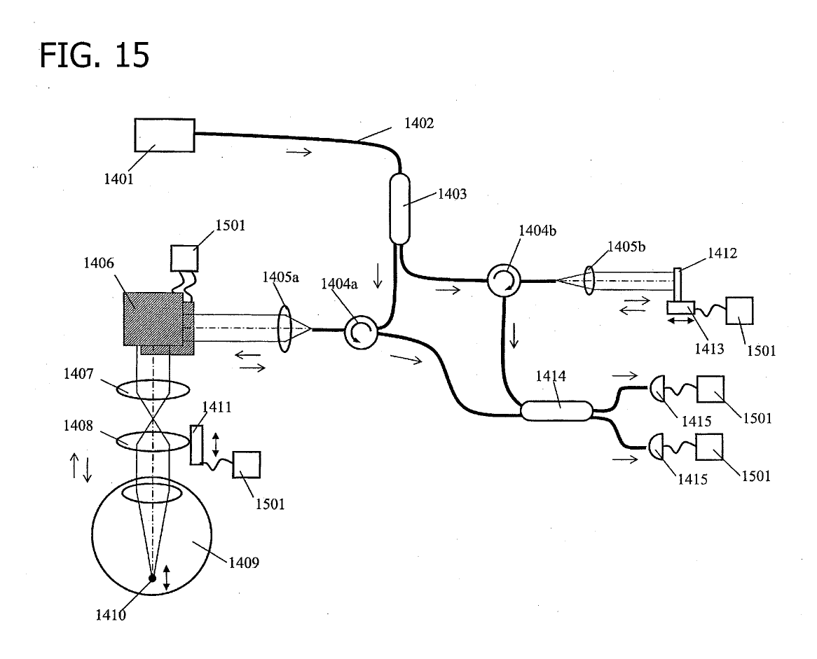

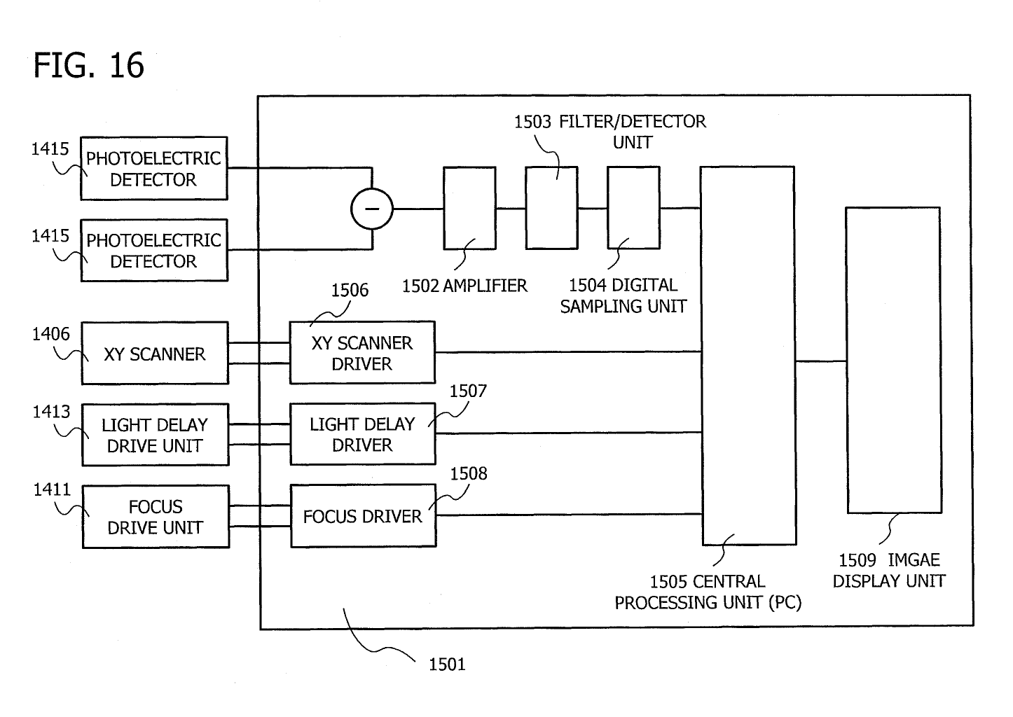

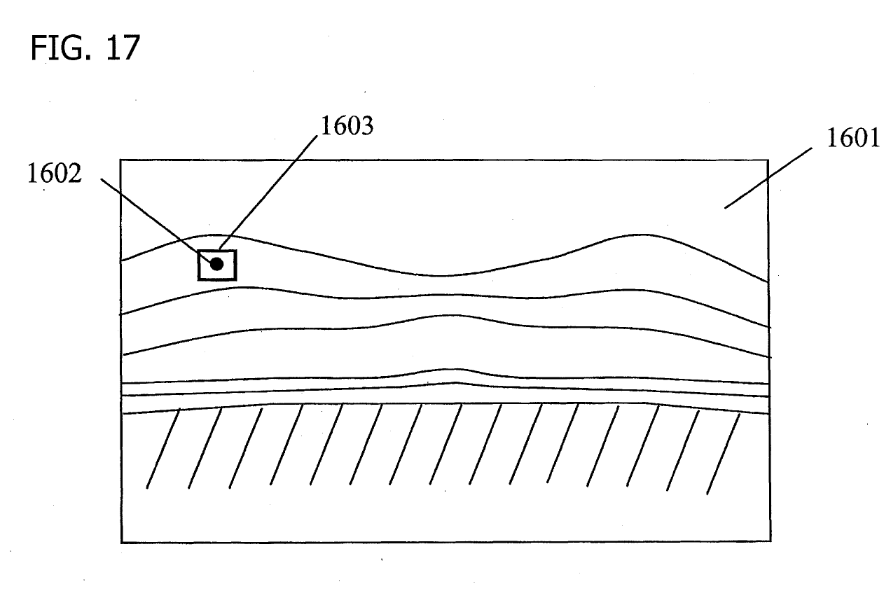

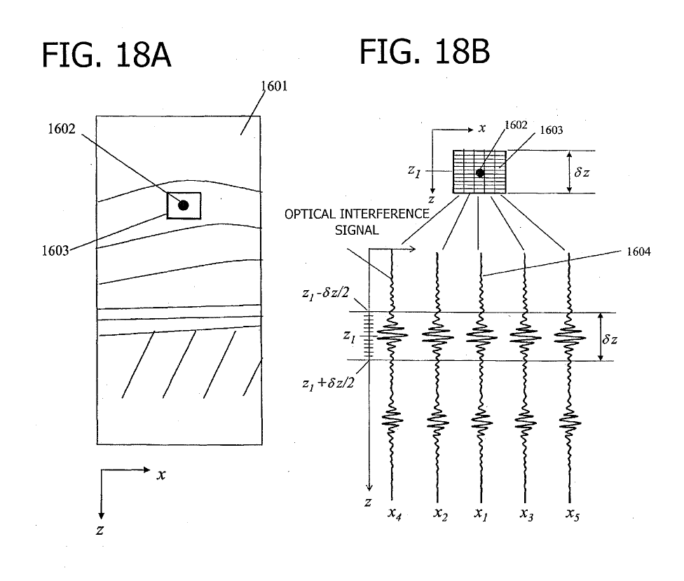

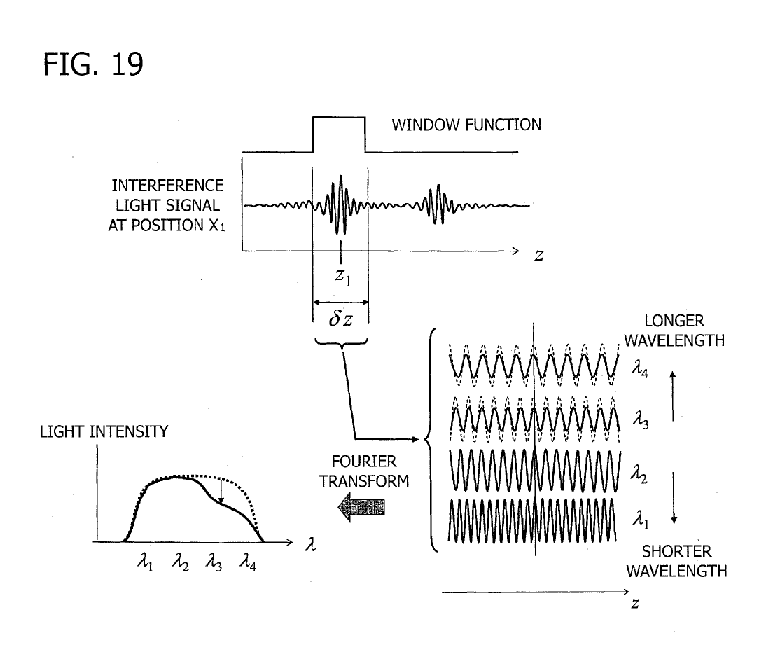

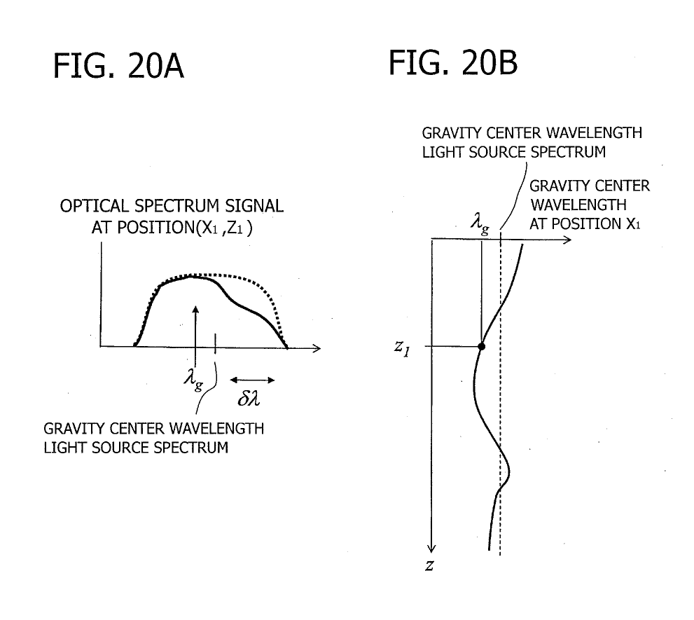

The window function is set as the rectangular function in the embodiments, and known variations such as a wavelet window function, the Hamming window function, and the like can be used as the window function. Further, when a window function corresponding to a shadow region is set, the window function may be weighed in the depth direction according to a degree of intensity of a interference signal of the shadow region, and upper and lower ends of a depth range of the shadow region designated by the window function may be variably processed as its utmost limit. In this case, a shadow region weighing unit 2001 may be added to the spectral information processing unit 104 as shown in, for example, FIG. 14.

### INDUSTRIAL APPLICABILITY

The optical coherence tomographic imaging apparatus as shown in the present invention, which can obtain highly accurate tomographic spectral information even to a fine structure, is useful to a diagnosis in an ophthalmologic field, in particular, a diagnosis of a blood flow and its degree of saturation oxygen or diagnosis of a cellular level, and a diagnosis using a molecular probe-contrast medium. Further, the optical coherence tomographic imaging apparatus of the present invention can be widely used for observation of a skin, observation of living body through an endoscope, and the like as well as for various types of diagnosis devices and inspection devices for industrial quality management and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-334530, filed on Dec. 26, 2008, which is hereby incorporated by reference herein in its entirety.

1. An optical coherence tomographic imaging apparatus for splitting light emitted from a light source into reference light and signal light and creating an optical coherence tomographic image and tomographic spectral information in a predetermined spectral analyzing portion in the optical coherence tomographic image base on optical interference signal information of the reference light and the signal light which are incident on an inspection target and reflected on respective layers, the optical coherence tomographic imaging apparatus comprising a spectral information processing unit which performs a spectral information calculation using an optical interference signal of a deeper region, which is positioned deeper than the spectral analyzing portion with respect to a light emitting direction, to create the tomographic spectral information of the spectral analyzing portion.

2. The optical coherence tomographic imaging apparatus according to claim 1, wherein the deeper region used for the spectral information calculation is in contact with the spectral analyzing portion.

3. The optical coherence tomographic imaging apparatus according to claim 1, wherein the deeper region used for the spectral information calculation includes a deepest portion in which the optical coherence tomographic image exits.

4. The optical coherence tomographic imaging apparatus according to claim 1, wherein the spectral information processing unit determines spectral information of the interference signal of the deeper region and creates the tomographic spectral information of the spectral analyzing portion based on a difference between the spectral information of the interference signal and the spectral information of the light emitted from the light source.

5. The optical coherence tomographic imaging apparatus according to claim 1, wherein the spectral information processing unit determines spectral information of the interference signal of the deeper region and spectral information of a interference signal of a region, which is a sum of the deeper region and at least a part of the spectral analyzing portion and creates tomographic spectral information of the spectral analyzing portion based on a difference between both pieces of the spectral information.

6. The optical coherence tomographic imaging apparatus according to any one of claims 1 to 5, comprising a spectral analyzing portion designation means for discriminating a portion whose spectral information is to be calculated in an optical coherence tomographic image and outputting the discriminated portion as spectral analyzing portion information.

7. The optical coherence tomographic imaging apparatus according to any one of claims 1 to 6, wherein the spectral information processing unit comprises:
deeper region calculation means for specifying a position and a range of the deeper region which is positioned deeper than the spectral analyzing portion with respect to a light emitting direction and outputting deeper region information;
deeper region spectral information calculation means for calculating and outputting tomographic spectral information corresponding to the deeper region;
analyzing portion spectral information calculation means for converting the tomographic spectral information of the deeper region to the tomographic spectral information of the spectral analyzing portion to which the deeper region corresponds and outputting the tomographic spectral information as analyzing portion tomographic spectral information; and
spectrum image creation means for performing an image creation processing for forming and displaying an image of the tomographic spectral information of the spectral analyzing portion on an optical coherence tomographic image.
